(19) United States
(12) Patent Application Publication
(10) Pub. No.: US 2018/0262471 A1
(43) Pub. Date: Sep. 13, 2018

(54) IDENTITY VERIFICATION AND AUTHENTICATION METHOD AND SYSTEM

(71) Applicants: EDGARD LOBO BAPTISTA PEREIRA, SAO PAULO (BR); AFFONSO GIAFFONE NETTO, SAO PAULO (BR); MARCELO BEZERRA ROSA, SAO PAULO (BR); JOHN C. SCHWINN, ST. PETERSBURG, FL (US)

(72) Inventors: EDGARD LOBO BAPTISTA PEREIRA, SAO PAULO (BR); AFFONSO GIAFFONE NETTO, SAO PAULO (BR); MARCELO BEZERRA ROSA, SAO PAULO (BR); JOHN C. SCHWINN, ST. PETERSBURG, FL (US)

(21) Appl. No.: 15/908,630

(22) Filed: Feb. 28, 2018

Related U.S. Application Data
(63) Continuation-in-part of application No. 14/253,967, filed on Apr. 16, 2014, now abandoned.
Application No. 14/253,967 is a continuation-in-part of application No. 13/865,536, filed on Apr. 18, 2013, now abandoned.
(60) Provisional application No. 61/635,260, filed on Apr. 18, 2012.
(60) Provisional application No. 61/696,345, filed on Sep. 4, 2012.
(60) Provisional application No. 61/786,704, filed on Mar. 15, 2013.

(51) Int. Cl. H04L 29/06

(52) U.S. Cl. CPC H04L 63/0428; H04L 63/08

(57) ABSTRACT

A system for developing user identification credentials that do not contain any pre-existing or static information. The user is identified through the user's computer, tablet computer, mobile computing device, or other computing device by means of single-use, time sensitive, system-generated identification credentials. The user presents the identification credentials to the system server, which decodes them and forwards the appropriate user identification number to the entity requiring the user identification.

This application is a continuation-in-part application of U.S. patent application Ser. No. 14/253,967, filed Apr. 16, 2014, which is a continuation-in-part application of U.S. patent application Ser. No. 13/865,536, filed Apr. 18, 2013, which claims benefit of and priority to U.S. Provisional Applications No. 61/635,260, filed Apr. 18, 2012, No. 61/696,345, filed Sep. 4, 2012, and No. 61/786,704, filed Mar. 15, 2013, and is entitled to those filing dates for priority, in whole or in part. The specifications, figures and complete disclosures of U.S. patent application Ser. Nos. 13/865,536 and 14/253,967, and U.S. Provisional Applications Nos. 61/635,260, 61/696,345, and 61/786,704, are incorporated herein in their entireties by specific reference for all purposes.

### FIELD OF INVENTION

This invention relates to a system and method for developing credentials to be used to determine the identity of a specific individual person or item, for example without limitation a computer or piece of data, that do not contain any static or pre-existing information. Further, no static or pre-existing information is exchanged between the individual or item to be identified and the entity confirming the identity in the identification transaction. Further, in some embodiments, in addition to determining identity, the generated credentials can be used to authenticate that identification, with both the identification and authentication completed with a single credential, all without (i) the credential containing any static or pre-existing information and (ii) without the exchange of any static or pre-existing information identity in the identification and authentication transaction. More specifically, this invention relates to a system and method that generates credentials that identify an individual person or item that do not contain any static or pre-existing information that (i) identify a user attempting to access a restricted resource or in certain financial and other transactions, whether on the Internet, phone, through a call center, via email, or in person; (ii) increase the security of certain financial and other transactions, whether on the Internet, phone, through a call center, via email, or in person; and (iii) eliminate the need for username and password on certain financial and other transactions, whether on the Internet, phone, through a call center, via email, or in person.

### BACKGROUND OF THE INVENTION

Identity fraud is a major and growing concern for both commercial participants and consumers in financial and other transactions. Identity fraud occurs in virtual transactions, such as a user logging into a secure website, and physical transaction, such as a consumer using a payment card at a local store. It is estimated that over 15 million US consumers had their identity stolen in 2016, resulting in financial losses of more than $16 billion. It is estimated that over 80% of all identity theft is a result of stolen or weak passwords.

In order to combat this fraud, a commercial operator must conduct at least two processes during each transaction. First, it must identify the user and then it must authenticate that user identification. As bad actors increase in sophistication, user authentication is increasingly being addressed in multiple processes, such as in some multi-factor authentication methods.

Prior to the present invention, a commercial operator has always been forced to use pre-existing static (non-changing) information to identify an individual. There are multiple examples of this—for example, username when logging into a website or other restricted resource, or a driver's license when presenting a payment card at a merchant. These pre-existing static pieces of information are vulnerable and subject to theft. Further, since processes were different for physical (in person) and virtual (Internet or phone) transactions, commercial operators typically incur unnecessary additional costs.

Database hacking or theft is also a significant and growing concern for commercial operators. Prior to the present invention, entities frequently maintained a “relational database,” that is, separate database files that were connected by a static link in order to secure sensitive information. To be successful, hackers would have to obtain access to both databases and the static link between them. Unfortunately, as hackers gain sophistication, they are more and more successful in achieving such thefts.

Examples of prior art devices and systems are disclosed in Laracey, U.S. Pub. No. 2012/0160912; Walker, U.S. Pat. No. 6,163,771; Hruska, U.S. Pub. No. 2012/0028609; Black, U.S. Pub. No. 2012/0132704; Macwan, U.S. Pat. No. 8,499,342; Dominguez, U.S. Pub. No. 2003/0200184; Tieken, U.S. Pat. No. 2011/0161233; Kean, U.S. Pub. No. 2009/0200371; Desai, U.S. Pub. No. 2013/0268437; Von Heesen, U.S. Pub. No. 2008/0077532; and Fuentes, U.S. Pub. No. 2012/0030047; all of which are incorporated herein by specific reference in their entireties for all purposes.

### SUMMARY OF INVENTION

In various exemplary embodiments, the present invention comprises a system and method to increase the security of various transactions on the Internet, on the phone, in person, or via email, by enabling a commercial operator to identify and verify a user with credentials that do not contain any pre-existing or static information.

The present invention represents a complete change from existing commercial practice in the prior art, as described above, in part due to four defining characteristics. Specifically, the present invention has the following characteristics: (i) it creates user identification credentials that do not contain any pre-existing or static information; (ii) only the user's specific registered computer and the system server are capable of encrypting and decrypting the transmitted information during any given user identification process or transaction; (iii) no single device contains all of the information required to generate the identification credentials (i.e., information must be gathered from two or more independent sources); and (iv) a single credential may be used to both identify and authenticate a user. The identification credentials can be used when identifying an individual or user in restricted resource access, financial or certain other transactions, regardless of whether the transaction is on the Internet, phone, through a call center, via email, or in person.

With regard to database hacking or theft, the present invention also represents a complete change from the vulnerable relational database systems known in the prior art. In several embodiments, the present invention enables commercial operators to completely separate these sensitive databases and eliminate all static links between them by generating a dynamic link on demand to create a link between elements of multiple databases.

In one embodiment, when integrated with a given website or page on the Internet, the present invention generates and interprets dynamic credentials that do not contain any pre-existing static information to identify a user during the login process. The present invention on demand generates and captures certain web session data from a website or page on the Internet using a system server and an application on the user's computer, tablet computer, mobile computing device, web browser, or other computing device. In this instance, the present invention, on a user's computer, generates encrypted dynamic credentials that uniquely identify the user, computing device, and the web session information. The present invention then transmits these credentials on the Internet to a central system server. The present invention installed on that server then decrypts the dynamic credentials to determine which unique registered user and computing device created them and passes this information to the website operator through a secure server-to-server connection. The website operator then provides appropriate access to the restricted resource to the user. The server may be hosted by the website operator or a third party.

After the registration process, all transactions between the system application on the user's computer, tablet computer, mobile computing device, web browser, or other computing device and the system server are encrypted for security and can be decrypted only by the system server or the user's specific registered computer.

The credentials generated by the present invention, whether the desired transaction is online, on the phone, or in person, contain no sensitive or valuable information. Therefore, even if the information is intercepted during transmission or subsequently, there is no risk of unauthorized use of the user's personal data or identity. The system also eliminates the need for the user to remember and input website specific usernames and passwords in the case of an Internet transaction.

### BRIEF DESCRIPTION OF THE DRAWINGS

FIG. 1 shows a diagram of the device registration process in accordance with an embodiment of the present invention.

FIG. 2 shows a diagram of the login user identification process in accordance with an embodiment of the present invention.

### DETAILED DESCRIPTION OF EXEMPLARY EMBODIMENTS

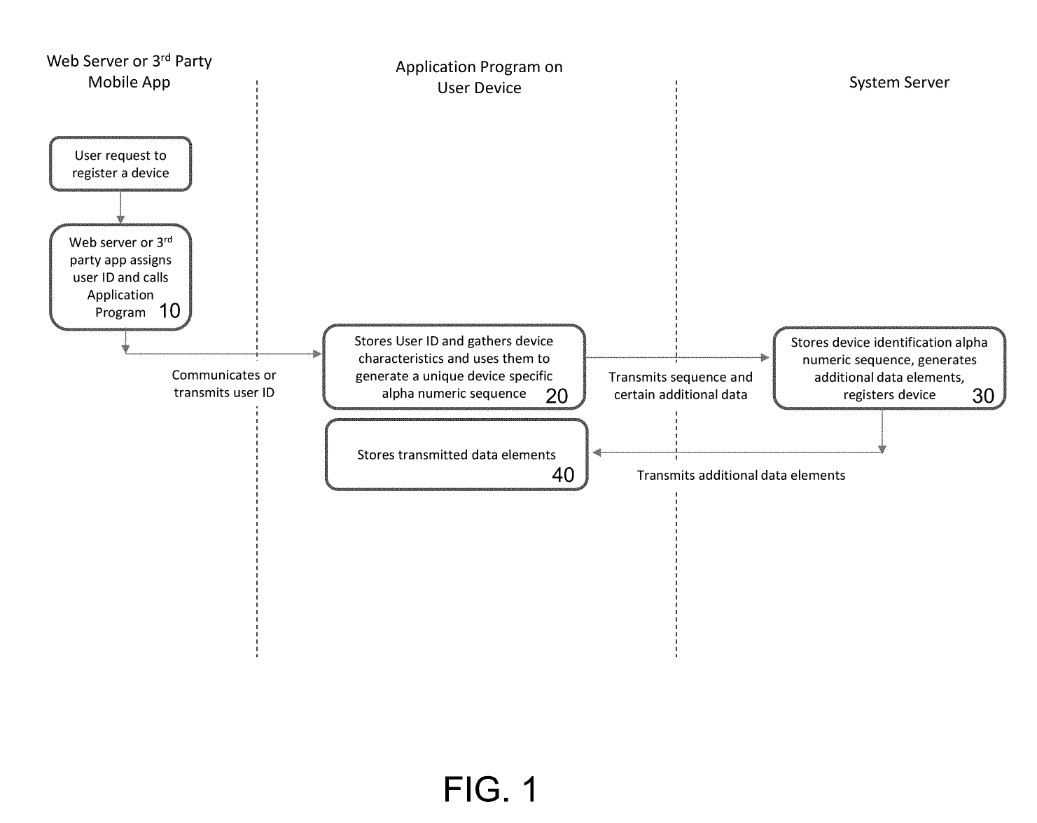

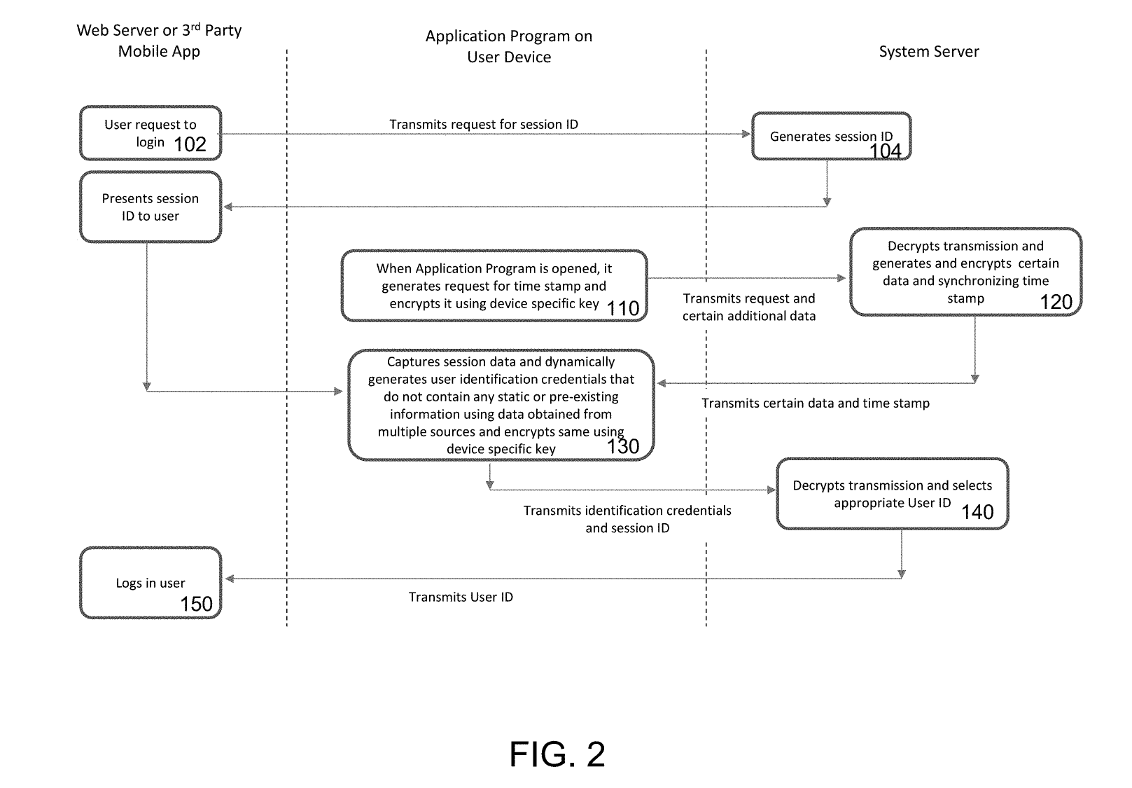

As seen in FIGS. 1 and 2, the present invention comprises a system and method to increase the security of various transactions on the internet, on the phone, in person, or via email, by determining the user's identity using credentials that contain no static or pre-existing information. During the device registration process, the present invention gathers and stores information related specifically to the user, including without limitation a user identification code and certain information related to the user's registered computers or computing devices. In one embodiment, when integrated with a given website or page on the Internet that an individual user desires to access, the present invention determines the identity of the individual during the user login process. All transactions between the present invention's application on the user's computer, tablet computer, mobile computing device, web browser, or other computing device and the present invention server are encrypted for security.

As seen in FIG. 1, the user downloads the application program from the system application server and it is installed on the user's computer or computing device. The system application server may be an app store, the website server, the system server, or another server. The application program may be a stand-alone application or a single or set of APIs that are integrated into a mobile application, such as a mobile banking application, and may be downloaded either at or prior to the time of user registration. During device registration, the system server (or other source) assigns a unique user ID code to the specific user 10. This user ID code may be developed by the website server, the system server, the user, or by another source and it is stored on the system server and is not stored on the user's registered computer. The application program then uses a proprietary algorithm to translate certain identifiable characteristics of the user's computer or computing device into a hash 20, which is transmitted and stored on the system server 30. The hash is not stored on the user's computer or computing device. The system server then transmits certain data elements to the application program; these data elements are stored on the user's computing device or computer 40.

When the system of the present invention is used to log into a website by a user on a given computing device or computer 102, the website server requests a session ID number from the system server. The system server then generates on demand a random session ID number 104 and communicates it to the website server. These communications are completed via a secure server to server connection. The website server subsequently presents the session ID number to the user as a QR-Code, bar code, or alpha numeric sequence.

The user opens the application program on the same or a different registered computer or computing device. The application program then encrypts certain data contained on the user's computer or computing device and transmits it to the system server. 110 The encrypted transmission can be created only by the specific registered user computer or computing device, and the encrypted data includes data that is specific to that specific registered computer or computing device. The system server decrypts the transmitted information to identify the user's computing device or computer 120 and sends back to the application program on the user's computer or computing device certain data, including without limitation a synchronizing time stamp. The application program on the user's computer or computing device decrypts the response using a proprietary algorithm and certain other stored information (i.e., stored on the user's computing device or computer) 130. If the user's computer or computing device is not the originally registered device, then the algorithm will fail in decrypting the response and the user will not be allowed access. If the application program successfully decodes the system server response, the user then inputs the session identification number into the application program, either by scanning the presented QR-Code or bar code, by entering the presented alpha numeric sequence, or some other method. Then, using an algorithm, the application program on the user's computer or computing device generates a dynamic, time-sensitive user identification credential that does not contain any static or pre-existing information, using information obtained from the website server, the system server, the user's computer, and the application program. The application program then provides these credentials to the system server, which then attempts to decrypt them 140. If successful, the system server provides the website server, via a secure server-to-server connection, with the user identification code of the user attempting to gain access to the website. The website server then logs in the user 150 and presents the relevant information to the user.

In several embodiments, the identification credentials comprise a unique data structure with an alpha-numeric sequence that uniquely identifies the registered computer or computing device, encrypted by the registered computer or computing using a dynamically generated hash based upon characteristics of the registered computer or computing device (in some embodiments, as many as 600 characteristics are used, and the number of characteristics uses as well as the specific characteristics may be predetermined, determined by an algorithm, or determined randomly) and data from multiple sources, including without limitation the registered device, the system server, and the website server. In one exemplary embodiment, the identification credentials comprise 2048 bits.

In sharp contrast to the prior art, the identification credentials of the present invention cannot be generated using only information stored either on the user's computing device or computer, or on the system server. Information from at least these two sources is necessary to create the identification credentials, which in turn contain only dynamic information and no static or pre-existing information (such as the user's name, account information, passwords, email address, personally identifiable static information, and the like). Further, only the original registered user computer or computing can generate the encrypted credentials, and only that user computer or computing device and the system server are capable of encrypting and decrypting the data transmissions during the user identification process.

In some embodiments, upon the user gaining access to the restricted resource, the system server sends a notification to other computers associated with the same user account that the access has been achieved. Upon receiving the notification, the user may use the system to terminate the attempted access if the access is not authorized by the user.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A computer-based method of developing on-demand dynamic credentials that do not contain any static or pre-existing information to identify a user attempting to access a restricted resource through dynamic user identification credentials containing no static or pre-existing information, comprising the steps of:
receiving, at a remote system server, a request from a restricted resource server for a session ID number;
generating, at the remote system server, a session ID number;
transmitting, from the remote system server, a session ID number to the restricted resource server;
transmitting, from a user device registered with the remote system server, an encrypted request for additional data from the remote system server, wherein the encrypted request includes certain data contained on the user device specific to that user device;
decrypting, at the remote system server, the encrypted request to identify the details of the request and confirm that the user device is a registered device;
generating, at the remote system server, an encrypted response to the encrypted request, the encrypted response including additional data comprising a synchronizing time stamp;
transmitting, from the remote system server, the encrypted response to the user device;
decrypting, at the user device, the encrypted response using information stored on the user device;
receiving, at the user device, the session ID number;
generating, in the user device, a dynamic user identification credential using information obtained from at least the remote system server and the user device, wherein the user identification credential contains no static or pre-existing information;
receiving, by the user device, the session ID number;
encrypting the user identification credential and session ID;
transmitting the encrypted user identification credential and session ID to the remote system server;
decrypting, at the remote system server, the encrypted user identification credential and session ID;
identifying the user identification for the particular restricted resource based upon the decrypted user identification credential; and
transmitting the user identification to the restricted resource service.

2. The method of claim 1, wherein the user device is a personal computer, a smart phone, tablet computer, or mobile computing device.

3. The method of claim 1, wherein the restricted resource is an online website.

4. The method of claim 1, wherein no single device or server stores all of the data or information necessary to generate the identification credentials.

5. The method of claim 1, wherein the encrypted request can only be generated at and encrypted by the user device, and can only be decrypted by the remote system, and further wherein the encrypted response can only be encrypted by the remote system server, and can only be decrypted by the user device that generated and sent the encrypted request.

6. The method of claim 1, wherein the user identification credential singularly is used to both identify and authenticate the user.

7. The method of claim 1, wherein the user and user device have been previously registered with the remote system server.

8. The method of claim 7, wherein multiple user devices have been previously registered with the remote system server.

9. The method of claim 7, wherein the remote system server generates and stores a unique user ID code for the user, and further wherein the unique user ID code is not stored on any user device.

10. The method of claim 9, wherein the remote system server receives and stores a hash using certain characteristics of the user device, and further wherein the hash is not stored on any user device.

11. The method of claim 10, wherein the remote system server generates and transmits certain data elements specific to the user device, and further wherein the certain data elements are stored on the user device.

12. The method of claim 1, wherein the dynamic user identification credential is generated using information obtained from the restricted resource server.

13. A computer-based method of developing on-demand dynamic credentials that do not contain any static or pre-existing information to identify a user when attempting to access a restricted resource, comprising the steps of:
opening an application program previously installed on a user's computing device when the user is attempting to access a restricted resource;
obtaining a time stamp from a remote system server through communication between the application program and the remote system server;
capturing a session ID from the restricted resource server into the application program;
combining the time stamp, certain characteristics of the user's computer, and certain data previously transmitted earlier from the system server into dynamically generated user identification credentials through a proprietary algorithm, wherein such credentials are an alpha numeric sequence that does not contain any static or pre-existing information;
encrypting the user identification credentials and transmitting them to a remote system server;
decrypting the user identification credentials to determine the originating device;
relating the device to a specific user identification; and
communicating the user identification from the remote system server to the restricted access server.

14. The method of claim 13, wherein the user device is a personal computer, a smart phone, tablet computer, or mobile computing device.

15. The method of claim 13, wherein the restricted resource is an online website.

16. The method of claim 13, wherein no single device or server stores all of the data or information necessary to generate the identification credentials.

17. The method of claim 13, wherein the encrypted request can only be generated and encrypted by the user device, and can only be decrypted by the remote system server.

18. The method of claim 13, wherein the encrypted response can only be encrypted by the remote system server, and can only be decrypted by the user device that generated and sent the encrypted request.

19. The method of claim 13, wherein the user and user device have been previously registered with the remote system server.

20. The method of claim 19, wherein multiple user devices have been previously registered with the remote system server.

21. The method of claim 19, wherein the remote system server generates and stores a unique user ID code for the user, and further wherein the unique user ID code is not stored on any user device.

22. The method of claim 21, wherein the remote system server receives and stores a hash using certain characteristics of the user device, and further wherein the hash is not stored on any user device.

23. The method of claim 22, wherein the remote system server generates and transmits certain data elements specific to the user device, further wherein the certain data elements are stored on the user device.
